(19) United States
(12) Patent Application Publication
(10) Pub. No.: US 2014/0024740 A1
(43) Pub. Date: Jan. 23, 2014

(54) CARPET BACKING COMPOSITIONS PREPARED FROM RECYCLED PAINT

(71) Applicants: James R. BARTLEY, Dalton, GA (US); Vance W. BROWN, Dalton, GA (US)

(72) Inventors: James R. BARTLEY, Dalton, GA (US); Vance W. BROWN, Dalton, GA (US)

(73) Assignee: ARROWSTAR, LLC, Dalton, GA (US)

(21) Appl. No.: 13/765,761

(22) Filed: Feb. 13, 2013

Related U.S. Application Data
(60) Provisional application No. 61/673,762, filed on Jul. 20, 2012.

(51) Int. Cl. C09D 131/04; C09D 109/08; C09D 133/00

(52) U.S. Cl. CPC C09D 131/04; C09D 133/00; C09D 109/08
USPC 523/122; 524/156; 524/157; 524/158; 524/425; 524/219; 524/197; 524/320; 524/319; 524/290; 524/42

(57) ABSTRACT

Described herein are carpet backing compositions prepared with paint. These compositions have (a) one or more first polymers, (b) one or more second polymers derived from a latex paint, (c) a filler, (d) a froth aid, and (e) a thickener. The compositions described herein solve several technical problems which have heretofore been inadequately addressed. The compositions described herein accept the required filler loading, can be applied easily without interference by paint components, have high solids contents, and dry or cure quickly. Methods for making the compositions and articles comprising the compositions are also described herein.

### CROSS REFERENCE TO RELATED APPLICATION

This application claims priority upon U.S. Provisional Application Ser. No. 61/673,762, filed Jul. 20, 2012. The application is hereby incorporated by reference in its entirety for all of its teachings.

### BACKGROUND

In 2007, the Carpet and Rug Institute (CRI), with the assistance of NSF International (NSF) and the American National Standards Institute (ANSI), developed through a consensus-based public process with a multi-stakeholder group of manufacturers, suppliers, regulatory agencies, customers, end users, academia, and other industry participants, a sustainability assessment standard for carpet products for the commercial market with an easy-to-understand certification for carpeting products. This standard, NSF/ANSI 140 Sustainability Assessment for Carpet, allows transparency and open understanding regarding conformance requirements, providing for more understandable and meaningful marketplace comparisons. Today, NSF/ANSI 140 Sustainability Assessment for Carpet, now simply referenced as NSF-140, is the foremost standard by which to evaluate and certify sustainability of commercial carpet products across their entire product life cycle.

Certification of carpet products under NSF-140 allows manufacturers to meet state and federal procurement guidelines, and provides a market-based definition from which consumers/customers can evaluate the sustainability of a manufacturer's product. The NSF-140 standard has three different levels of certification: silver, gold, and platinum. The platinum certification is the most desirable and is specified by the majority of the installation contracts of government and industry jobs. One of the main prerequisites for platinum certification under NSF-140 is that the carpet products contain a minimum of 10% post-consumer recycled content by weight. Today, this requirement is mainly being achieved through the use of post-consumer recycled glass (commonly called cutlet) and post-consumer recycled polyvinyl chloride (PVC).

Described herein is an alternative approach to the above referenced post-consumer recycled materials with the incorporation of post-consumer recycled latex paint into the carpet backing composition. The use of post-consumer recycled paint as an alternative material to achieve the recycle content requirements of NSF-140 platinum certification is desirable with the consumers of these carpet products due to the obvious environmental benefit of recycling post-consumer latex paint versus disposal of these materials into a landfill. In addition, the use of post-consumer recycled paint is desirable from the manufacturers of carpet products due to the severe equipment wear experienced by them when incorporating cutlet into their manufacturing process. Lastly, some consumers have concerns with the use and manufacture of PVC products. Thus, the compositions described herein will be perceived as a true environmental alternative for carpet products that they can purchase.

### SUMMARY

Described herein are carpet backing compositions prepared with paint. These compositions have (a) one or more first polymers, (b) one or more second polymers derived from a latex paint, (c) a filler, (d) a froth aid, and (e) a thickener. The compositions described herein solve several technical problems which have heretofore been inadequately addressed. The compositions described herein accept the required filler loading, can be applied easily without interference by paint components, have high solids contents, and dry or cure quickly. Methods for making the compositions and articles comprising the compositions are also described herein.

Additional advantages of the compositions, methods, and articles described herein will be set forth in part in the description that follows, and in part will be apparent from the description. The advantages of the compositions, methods, and articles described herein will be realized and attained by means of the elements and combinations particularly pointed out in the appended claims. It is to be understood that both the foregoing general description and the following detailed description are exemplary and explanatory only and are not restrictive of the compositions, methods, and articles described herein, as claimed.

### DETAILED DESCRIPTION

The compositions, methods, and articles described herein can be understood more readily by reference to the following detailed description. It is also to be understood that the terminology used herein is for the purpose of describing particular aspects only and is not intended to be limiting.

It must be noted that, as used in the specification and the appended claims, the singular forms “a,” “an” and “the” include plural referents unless the context clearly dictates otherwise. Thus, for example, reference to “a polymer” includes mixtures of two or more polymers.

Disclosed are materials and components that can be used for, can be used in conjunction with, can be used in preparation for, or are products of the disclosed compositions and methods. These and other materials are disclosed herein, and it is understood that when combinations, subsets, interactions, groups, etc. of these materials are disclosed that while specific reference of each various individual and collective combination and permutation of these compounds may not be explicitly disclosed, each is specifically contemplated and described herein. For example, if a filler is disclosed and discussed and a number of different froth aids are discussed, each and every combination and permutation of filler and froth aid that are possible are specifically contemplated unless specifically indicated to the contrary. For example, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Described herein are carpet backing compositions prepared with paint. Carpet backing compositions are generally used to adhere tufted fibers to the primary backing of carpet. In one aspect, the paint can be a water-based latex paint. In another aspect, the paint can be a recycled paint such as, for example, a recycled water-based latex paint. The use of latex paints such recycled latex paints to produce carpet backing formulations present several problems with respect to the preparation and use of carpet backing compositions. Some of these problems include, but are not limited to:
1. the acrylic base polymer in paint does not accept the necessary filler loading;
2. the paint contains defoamers and leveling agents that hinder the application of the carpet backing compositions as a foam;
3. the paint has a low solids content (typically 45%) compared to current carpet backing compositions (e.g., typically about 80%), which inhibits the curing and drying of the carpet backing composition when applied to the carpet backing; and
4. the paint contains glycols, which tends to slow drying and curing.
   The compositions and methods for making the same address these issues.

In one aspect, the composition includes:
(a) one or more first polymers comprising polyvinyl acetate, polyvinyl chloride, a polyacrylate, an acrylic copolymer, a polyethylene-vinyl acetate copolymer, a styrene-butadiene copolymers (SBR), a polyurethane dispersions, a carboxylated styrene-butadiene copolymer, an ethylene vinyl acetate copolymer, or any combination thereof:
(b) one or more second polymers derived from a latex paint;
(c) a filler;
(d) a froth aid; and
(e) a thickener,
   wherein (i) the ratio of filler/sum of the first and second polymer in dry parts is from 1:1 to 8:1;
(ii) the amount of froth aid is from 1% to 10% of the sum of the first and second polymer in dry parts;
(iii) the composition has a solids content of from at least 50% to 85%; and
(iv) the composition has a viscosity of from at least 4,000 cps to 25,000 cps.

Each component in the compositions and methods for making the same are described below.

The first polymer useful herein can be any polymer typically used in carpet backing formulations. In one aspect, the first polymer is a polyvinyl chloride, polyacrylates and acrylic copolymers, polyethylene-vinyl acetate copolymers, styrene-butadiene copolymers (SBR), polyurethane dispersions, carboxylated styrene-butadiene copolymers, ethylene vinyl acetate copolymers, or any combination thereof.

In other aspects, the first polymer can be an aqueous dispersion of a flexible crosslinkable COOH-containing polymer or mixtures of polymers. Examples of such polymers are the copolymers of butadiene, isoprene, 2,3-dimethyl butadiene and other dienes of 4 to 6 carbon atoms with a copolymerizable unsaturated acid such as acrylic acid, methacrylic acid, maleic acid, maleic anhydride, fumaric acid, itaconic acid, vinyl benzoic acid, α-chloro acrylic acid, crotonic acid, and the like and mixtures thereof. There, also, may be copolymerized with the diene and acid monomer one or more other copolymerizable monomers such as styrene, α-methyl styrene, vinyl toluene, acrylonitrile, methacrylonitrile, methyacrylate, ethylacrylate, butyl acrylate, ethyl hexylacrylate, methyl methacrylate, hydroxy ethyl acrylate, hydroxy propyl acrylate, hydroxy ethyl methacrylate, acrylamide, methacrylamide, and the like and mixtures thereof. Still other polymers can be used such as the copolymers of one or more of the above acrylates and one or more of the above acrylic acids. The addition of the third, fourth, etc. monomer will be determined by the need for compatibility with the carpet materials, stiffness, and the toughness, strength, water and solvent resistance and so forth desired. Even more preferred copolymers to use are the aqueous emulsions of flexible carboxylated butadiene styrene copolymers, e.g., copolymers of butadiene, styrene and at least one acid selected from the group consisting of acrylic, methacrylic, fumaric, maleic, and itaconic acids optionally with a hydroxy lower alkyl acrylate. These copolymers may be prepared in aqueous emulsion systems using conventional emulsifiers, chain transfer agents, antioxidants, short-stop agents, free radical catalysts and so forth as well known to the art. Methods for making these polymers are disclosed in U.S. Pat. Nos. 2,604,668; 2,669,550; 2,710,292; 2,724,707; 2,849,426; 2,868,754; 3,392,048; 3,404,116; 3,409,569; and 3,468,833. In one aspect, the first polymer is ethylene vinyl acetate copolymer sold under the tradename Elvace 97824, which is manufactured by Forbo Polymers.

The second polymer(s) useful herein are derived from a latex paint. In one aspect, the latex paint is recycled latex paint. The latex paint is generally a water-based paint composed of a dispersion of one or more polymers (i.e., second polymer(s)). In one aspect, the latex paint has a solids content of 40% to 70%.

In one aspect, the solids content of the latex paint is increased by allowing the paint to separate naturally and drawing off the supernatant liquid. In another aspect, the solids content of the latex paint is increased by removal of water through centrifugation. In yet another aspect, the solids content of the latex paint is increased through vacuum evaporation.

The latex paint contains a variety of different second polymers such as, for example, acrylics, vinyl acrylic, acrylic copolymer, polyvinyl acetate, styrene butadiene polymer, ethylene vinyl acetate copolymer, and combinations thereof. The amount of second polymer present in the paint can vary, which can be determined using techniques known in the art. In some aspects, the latex paint can be concentrated through the removal of water. In other aspects, typical latex paint additives such as defoamers, leveling agents, glycols, and the like, can be removed prior to making the compositions described herein. In one aspect, typical latex paint additives are removed by allowing the paint to separate naturally and drawing off the supernatant liquid. In a further aspect, typical latex paint additives such as glycols, glycol ethers, and defoamers are water soluble and segregate to the supernatant liquid when the latex paint is allowed to separate.

The compositions described herein include a filler. Fillers typically used in the preparation of carpet backing formulations can be used herein. Non-limiting examples of suitable fillers include sand, talc, dolomite, calcium carbonate, clay, silica, mica, wollastonite, feldspar, aluminum silicate, alumina, hydrated alumina, glass bead, glass microsphere, ceramic microsphere, thermoplastic microsphere, barite, wood flour, and combinations thereof. In one aspect, the filler can be a recycled mineral filler (RMF). Examples of recycled mineral fillers useful herein include those manufactured by Cimbar sold under the tradename Cimbar RMF-45, RMF-55 and RMF-75, which is limestone as the predominant component silicon dioxide, aluminum oxide, aluminum hydroxide, ferric oxide, magnesium oxide, calcium oxide, sodium oxide, potassium oxide, calcium carbonate, barium sulfate, and oxidized asphalt.

The compositions described herein include a froth aid. In one aspect, the froth aid is an anionic, cationic, or neutral surfactant. In one aspect, the anionic surfactant can be a sulfate and sulfonate, although other types, such as soaps, long-chain N-acyl sarcosinates, salts of fatty acid cyanamides or salts of ether carboxylic acids, of the type obtainable from long-chain alkyl or alkylphenyl poly-ethylene glycol ethers and chloroacetic acid, can also be used. The anionic surfactant can be used in the form of the alkali metal or alkali earth metal salt.

In one aspect, froth aids of the sulfate type can be sulfuric acid monoesters of long-chain primary alcohols of natural and synthetic origin containing from 10 to 20 carbon atoms, i.e. of fatty alcohols such as, for example, coconut oil fatty alcohols, tallow fatty alcohols, oleyl alcohol, or of C₁₀-C₂₀ oxoalcohols and those of secondary alcohols having chain lengths in the same range. Sulfated fatty acid alkanolamides and sulfated fatty acid monoglycerides are also suitable. In one aspect, the froth aid is ammonium dodecyl sulfate sold under the tradename Starfroth HG-3 manufactured by ArrowStar, LLC.

In another aspect, froth aids of the sulfonate type can be a salt of sulfosuccinic acid monoesters and diesters containing from 6 to 22 carbon atoms in the alcohol portions, alkylbenzene sulfonates containing C₉-C₁₅ alkyl groups and lower alkyl esters of α-sulfofatty acids, for example the α-sulfonated methyl or ethylesters of hydrogenated coconut oil fatty acids, hydrogenated palm kernel oil fatty acids or hydrogenated tallow fatty acids. Other suitable froth aids of the sulfonate type are the alkane sulfonates obtainable from C₁₂-C₁₈ alkanes by sulfochlorination or sulfoxidation and subsequent hydrolysis or neutralization or by addition of bisulfites onto C₁₂-C₁₈ olefins and also the olefin sulfonates i.e. mixtures of alkene and hydroxyalkane sulfonates and disulfonates, obtained for example from long-chain monoolefins containing a terminal or internal double bond by sulfonation with gaseous sulfur trioxide and subsequent alkaline or acidic hydrolysis of the sulfonation products.

One or more thickeners can be used to increase the viscosity of the compositions described herein. Thickeners suitable for use in the practice of the present invention can be any known in the art such as for instance poly-acrylate type or associate non ionic thickeners such as modified cellulose ethers. For example, suitable thickeners include ALCOGUM™ VEP-II (trade name of Alco Chemical Corporation), Rheovis™ and Viscalex™ (trade names of Ciba Geigy), UCAR® Thickener 146, or Ethocell™ or Methocell™ (trade names of the Dow Chemical Company) and PARAGUM™ 241 (trade name of Para-Chem Southern, Inc.), or Bermacol™ (trademark of Akzo Nobel) or Aqualon™ (trademark Hercules) or ACUSOL™ (trademark Rohm and Haas). In another aspect, the thickener is a polyacrylate such as, for example, Paragum 277 manufactured by Para-Chem.

In other aspects, the compositions described herein can include one or more of the following, optional components: dispersants, fire retardants, pigments, antistatic agents, reinforcing fibers, antioxidants, a neutralizing agent, a rheology modifier, preservatives, biocides, acid scavengers, a wetting agent, and the like.

When preparing the compositions described herein, certain considerations as discussed above need to be taken into account. Not wishing to be limited by theory, the following items are considered when preparing carpet backing compositions using paint (e.g., recycled paint).
1. identify the amount of the second polymer in the paint in the final composition;
2. identify the filler loading range, taking into account the paint may also contain filler;
3. identify the amount of froth aid needed to overcome the defoamers and levelers present in the paint;
4. determine the solids level needed to permit sufficient drying and curing of the carpet backing composition in the oven; and
5. identify the first polymers to use in conjunction with the second polymers present in the paint.

A general procedure for producing the carpet backing compositions is described herein, with a non-limiting procedure provided in the Examples. First, one or more first polymers are admixed with the paint containing one or more second polymers in a mixer typically used in the art. The mixing time is sufficient to produce a homogeneous mixture. The amount of first polymer and paint that are admixed with one another can vary. For example, the paint can contain varying amounts of second polymer(s). The amount of second polymer can be determined using techniques known in the art.

After the first polymer and paint have been admixed, the filler is added to the mixture. In one aspect, the amount of filler that is added is in the ratio 1:1 to 8:1 filler (dry parts)/sum of the first and second polymer (dry parts). In other aspects, the ratio is from 1:1 to 5:1; 2:1 to 5:1; 2:1 to 3:1; or 4:1 to 5:1. When calculating the amount of filler that is used, the amount of filler that is present in the paint is also taken into account. An example of this is provided in the Examples. In the Examples, a 200 load formulation has 200 dry parts filler. In this formulation, 136 dry parts filler was added to the formulation, with 64 dry parts already present in the paint. In this formulation, the there are 100 dry parts of first and second polymer, where the first polymer (Elvace 97824) was added in the amount of 49 dry parts and the paint contained 51 dry parts of the second polymer.

The amount of first polymer, second polymer, and filler determines the total solids content of the formulation. As discussed above, the composition has to have a sufficient solids content in order to permit sufficient drying and curing of the carpet backing composition in the oven. In one aspect, the amount of first polymer, second polymer, and filler present in the composition is sufficient to produce a composition having a solids content of at least 50%. In another aspect, the solids content is from 50% to 85%, 50% to 70%, 50% to 65%, or 60% to 65%. In a further aspect, the solids content is from 70% to 85%, 75% to 85%, or 80% to 85%

After the addition of the filler, the froth aid is added and admixed so that the froth is evenly dispersed throughout the mixture. As discussed above, paints typically contain defoamers and levelers, which reduces the ability of the carpet backing formulation to be applied as a foam to the carpet backing. In one aspect, the amount of froth aid is from 1% to 10% of the sum of the first and second polymer in dry parts. In other aspects, the amount of froth aid is from 2% to 8%, 2% to 5%, 2.5% to 3.5%, or about 3% of the sum of the first and second polymer in dry parts. Referring to the Examples, 3 dry parts froth aid is used relative to 100 parts of first and second polymer. Here, the froth aid is 3% of the sum of the first and second polymer in dry parts.

After the froth aid has been added, the viscosity of the formulation can drop. In order to increase the viscosity of the formulation, one or more thickeners are added to the formulation. In one aspect, the amount of thickener is from 0.1% to 10% of the sum of the first and second polymer in dry parts. In other aspects, the amount of thickener is from 0.5% to 8%, 1% to 8%, 2% to 8%, 2% to 5%, 2.5% to 4%, or about 3.5% of the sum of the first and second polymer in dry parts. Referring to the Examples, 3.6 dry parts thickener is used relative to 100 parts of first and second polymer. Here, the thickener is 3.6% of the sum of the first and second polymer in dry parts. In one aspect, the amount of thickener present in the composition is sufficient to produce a composition having a viscosity of at least 4,000 cps. In another aspect, the composition has a viscosity of 4,000 cps to 25,000 cps, 5,000 cps to 9,000 cps, or 6,000 cps to 8,000 cps.

The compositions described herein can be applied to the back of the carpet by techniques known in the art including, but not limited to, air knife coating, blade coating, brush-finish coating, cast coating, flow-on coating, knife coating, machine coating, polished drum coating, print on coating, roll coating, spray coating, wire wound rod coating or other methods known to the art for coating the backing of a carpet.

The compositions can be applied to any secondary backing material. The secondary backing material or layer can be made of any natural or synthetic fibers or mixtures thereof such as cotton, rayon, nylon, polyesters, polypropylene, acrylics, hair or bast and so forth and is usually made of square woven fibers. Bast fibers include jute, flax, hemp, sunn, ramie, henaf, urena, nettle and the like. The compositions described herein can be used to make carpet products using techniques well-known in the art.

### EXAMPLES

The following examples are put forth so as to provide those of ordinary skill in the art with a complete disclosure and description of how the compositions and methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Preparation of Carpet Backing Composition with Recycled Paint

The standard formula is based on 100 dry parts of polymer (latex). The remaining components are multiples or fractions of the polymer content. For example, a 200 load formula contains 200 dry parts of filler per 100 dry parts of polymer.

### 200 Load Filler/100 Load Polymer

| Ingredient | wet parts | % solid | dry parts |
|---|---|---|---|
| Recycled Paint | 255 | 45 | 115 |
| (interior/exterior acrylic) | | | (51 polymer 64 filler) |
| Elvace 97824 | 75 | 65 | 49 |
| (VAE, Forbo Polymers) | | | |
| Filler (calcium carbonate) | 136 | 100 | 136 |
| Froth Aid (Starfroth HG-3) | 10 | 30 | 3 |
| Thickener (Paragum 277) | 30 | 12 | 3.6 |

Compound Solids: 60
Viscosity: 6,000-8,000 cps

### 425 Load Filler

| Ingredient | wet parts | % solid | dry parts |
|---|---|---|---|
| Recycled paint | 74 | 54 | 40 |
| | | | (22 polymer/18 filler) |
| Water | 8.5 | N/A | N/A |
| GenCal NC7510 | 142.9 | 56 | 80 |
| (SBR latex) | | | |
| Filler (calcium carbonate) | 329 | 100 | 329 |
| Filler (Cimbar RMF-45) | 76 | 100 | 76 |
| Froth Aid (Starfroth HG-3) | 10 | 28 | 2.8 |
| Thickener | 5 | 15 | 0.75 |

Total Solids: 81.9%
Paint: 7.56% by wet weight, 20% by weight of polymer
Post-Consumer Recycled Content: 22%

### Compounding Instructions:

1) Charge polymer (latex) to mix tank capable of blending the material at the viscosity expected with variable speed mixing and proper baffling to prevent entrainment of air during the blending procedure, then mix until homogeneous (2-3 minutes).
2) Slowly add filler at a rate that allows the filler to wet prior to the next addition.

Care must be taken at this step to avoid agglomeration of the filler and entrainment of air. This step may takes 10-30 minutes depending on batch size. Stir for an additional 10-20 minutes after all filler has been added. Next, record the viscosity after adding filler.
3) Add the froth aid and stir 3-5 minutes, viscosity will normally drop at this point and stirring rate must be adjusted to avoid foaming. The viscosity is measured and recorded at this point.
4) Add any other ingredients at this point (i.e. bacteriocides), excluding thickener.
5) Add thickener as needed to increase viscosity to specification, where possible to minimize the addition of thickener to 2 additions. The mixture is stirred for 10-15 minutes to ensure homogeneity and produce the final carpet backing formulation.
6) Record final viscosity.

Throughout this application, various publications are referenced. The disclosures of these publications in their entireties are hereby incorporated by reference into this application in order to more fully describe the compounds, compositions and methods described herein.

Various modifications and variations can be made to the materials, methods, and articles described herein. Other aspects of the materials, methods, and articles described herein will be apparent from consideration of the specification and practice of the materials, methods, and articles disclosed herein. It is intended that the specification and examples be considered as exemplary.

What is claimed:

1. A composition comprising:
(a) one or more first polymers comprising polyvinyl acetate, polyvinyl chloride, a polyacrylate, an acrylic copolymer, a polyethylene-vinyl acetate copolymer, a styrene-butadiene copolymers (SBR), a polyurethane dispersions, a carboxylated styrene-butadiene copolymer, an ethylene vinyl acetate copolymer, or any combination thereof:
(b) one or more second polymers derived from a latex paint;
(c) a filler;
(d) a froth aid; and
(e) a thickener,
wherein (i) the ratio of filler/sum of the first and second polymers in dry parts is from 1:1 to 8:1;
(ii) the amount of froth aid is from 1% to 10% of the sum of the first and second polymer in dry parts;
(iii) the composition has a solids content of from at least 50% to 85%; and
(iv) the composition has a viscosity of from at least 4,000 cps to 25,000 cps.

2. The composition of claim 1, wherein the carboxylated styrene-butadiene copolymer comprises a copolymerizable unsaturated acid.

3. The composition of claim 2, wherein the copolymerizable unsaturated acid comprises acrylic acid, methacrylic acid, maleic acid, maleic anhydride, fumaric acid, itaconic acid, vinyl benzoic acid, α-chloro acrylic acid, crotonic acid, and mixtures thereof.

4. The composition of claim 2, wherein the carboxylated styrene-butadiene copolymer further comprises one or more copolymerizable monomers selected from the group consisting of α-methyl styrene, vinyl toluene, acrylonitrile, methacrylonitrile, methacrylate, ethylacrylate, butyl acrylate, ethyl hexylacrylate, methyl methacrylate, hydroxyethyl acrylate, hydroxypropyl acrylate, hydroxyethyl methacrylate, acrylamide, methacrylamide, and mixtures thereof.

5. The composition of claim 1, wherein the first polymer comprises a copolymer of butadiene, styrene and one copolymerizable unsaturated acid selected from the group consisting of acrylic acid, methacrylic acid, fumaric acid, maleic acid, and itaconic acid, and optionally comprises a hydroxy lower alkyl acrylate.

6. The composition of claim 1, wherein the first polymer comprises an ethylene vinyl acetate copolymer.

7. The composition of claim 1, wherein the first polymer comprises an aqueous emulsion.

8. The composition of claim 1, wherein the second polymer comprises an acrylic polymer, a vinyl acrylic polymer, an acrylic copolymer, polyvinyl acetate, styrene butadiene polymer, ethylene vinyl acetate copolymer, or a combination thereof.

9. The composition of claim 1, wherein the latex paint is a recycled latex paint.

10. The composition of claim 1, wherein the latex paint is a water-based latex paint.

11. The composition of claim 10, wherein the latex paint has a solids content of 40% to 70%.

12. The composition of claim 1, wherein the latex paint does not include a defoamer, a leveling agent, and a glycol.

13. The composition of claim 1, wherein the filler comprises sand, talc, dolomite, calcium carbonate, clay, silica, mica, wollastonite, feldspar, aluminum silicate, alumina, hydrated alumina, glass beads, glass microspheres, ceramic microspheres, thermoplastic microspheres, barite, wood flour, or a combination thereof.

14. The composition of claim 1, wherein the filler comprises a recycled mineral filler.

15. The composition of claim 1, wherein the ratio of filler to the sum of the first and second polymers in dry parts is from 1:1 to 5:1.

16. The composition of claim 1, wherein the froth aid is an anionic surfactant, a cationic surfactant, a neutral surfactant, or a combination thereof.

17. The composition of claim 16, wherein the froth aid is an anionic surfactant.

18. The composition of claim 17, wherein the anionic surfactant comprises a sulfate, a sulfonate, a soap, a long-chain N-acyl sarcosinate, a salt of a fatty acid cyanamide, a salt of an ether carboxylic acid, a salt obtained from a long-chain alkyl or an alkylphenyl polyethylene glycol ether and chloroacetic acid, or a combination thereof.

19. The composition of claim 17, wherein the anionic surfactant comprises a sulfate.

20. The composition of claim 19, wherein the sulfate comprises a sulfuric acid monoester of a long-chain primary alcohol of natural or synthetic origin containing from 10 to 20 carbon atoms, a sulfated fatty acid alkanolamine, a sulfated fatty acid monoglyceride, or a combination thereof.

21. The composition of claim 19, wherein the sulfate comprises ammonium dodecyl sulfate.

22. The composition of claim 17, wherein the anionic surfactant comprises a sulfonate.

23. The composition of claim 22, wherein the sulfonate comprises a salt of a sulfosuccinic acid monoester or diester containing from 6 to 22 carbon atoms in the alcohol portion, an alkylbenzene sulfonate containing a C₉-C₁₅ alkyl group, a lower alkyl ester of an α-sulfofatty acid, an alkane sulfonate, an olefin sulfonate, or a combination thereof.

24. The composition of claim 1, wherein the amount of froth aid is from 2% to 5% of the sum of the first and second polymers in dry parts.

25. The composition of claim 1, wherein the thickener comprises a polyacrylate or a modified cellulose ether.

26. The composition of claim 25, wherein the polyacrylate is a sodium polyacrylate.

27. The composition of claim 1, wherein the amount of thickener is from 0.1% to 10% of the sum of the first and second polymers in dry parts.

28. The composition of claim 1, optionally comprising dispersants, fire retardants, pigments, antistatic agents, reinforcing fibers, antioxidants, neutralizing agents, rheology modifiers, preservatives, biocides, acid scavengers, a wetting agent, or a combination thereof.

29. The composition of claim 1, wherein the composition comprises a solids content of from at least 60% to 85%.

30. The composition of claim 1, wherein the composition has a viscosity of from about 8,000 cps to about 18,000 cps.

31. An article comprising the composition of claim 1.

32. The article of claim 31, wherein the article is a floor covering.

33. The floor covering of claim 32, wherein the floor covering is carpet, carpet tile, or a rug.
